(19) United States
(12) Patent Application Publication
(10) Pub. No.: US 2006/0292307 A1
(43) Pub. Date: Dec. 28, 2006

(54) COATING METHOD FOR A CLEAR POLISHING PAINT TO PREVENT ADHESION MARKS AFTER PACKAGING

(75) Inventors: Ying-Tang Hsu, Taipei City (TW); Kevin Chean, Taipei City (TW); Chun-Chung Chiou, Linkou Township (TW); Chia-Hsuan Chang, Lujhu Township (TW); Stephen Tsai, Sijhih City (TW); Yao-To Tseng, Sindian City (TW); Yu-Cheng Teng, Taipei City (TW); Jay Zhong, Tucheng City (TW)

Correspondence Address: BACON & THOMAS, PLLC, 625 SLATERS LANE, FOURTH FLOOR, ALEXANDRIA, VA, 22314, US

(73) Assignee: Hannspree, Inc., Taipei City (TW)

(21) Appl. No.: 11/269,608

(22) Filed: Nov. 9, 2005

(30) Foreign Application Priority Data
Jun. 22, 2005 (TW) 094120772

(51) Int. Cl. B05D 7/00

(52) U.S. Cl. 427/402

(57) ABSTRACT

A coating method for a clear polishing paint to prevent adhesion marks, includes: providing a plastic substrate coated with a base coat, and a clear polishing paint mixture solution, the clear polishing paint mixture solution contains a hardener part and a PU clear paint; coating the clear polishing paint mixture solution on a surface of the substrate, and heating the substrate coated with the clear polishing paint mixture solution at 60° C.˜75° C. for 0.5˜2 hours; and keeping the substrate coated with the clear polishing paint mixture solution stationary.

### BACKGROUND OF THE INVENTION

1. Field of the Invention

The present invention relates to a coating method for a clear polishing paint, and more particularly, to a coating method for a clear polishing paint that is not easily softened by high temperatures, thus to reduce the adhesion marks appear on the product surface after packaging.

2. Description of the Related Art

To improve product appearance, the manufacturers of the so-called 3C products tend to partially or completely add clear polishing paint coatings on their products after a coat of paint. However, during transportation, the clear polishing paint layer on the surface of the product may soften due to high temperatures in the shipping container; the softened clear polishing paint is then pressed by the tight packing, which forms surface adhesion marks. Products having portions of clear polishing paint coatings can be protected by special package designs, but this is not effective for products completely covered with clear polishing paint coatings.

A two-step process is well known in the skilled art. A UV clear polishing paint is sprayed onto the outer surface of a product, the coated product is then placed under UV light. The coated surface of the product is polished and the abrading marks can be reduced. However, the UV clear polishing paint has some limitations; if the product has grooves or uneven surfaces, the UV light may not be able to reach the entire surface, and the UV clear polishing paint may crack, or curved surfaces may not harden. Therefore, this technique is limited by the shape of the product.

Moreover, for consumer electronic products that primarily have plastic substrates, most of their shell materials are ABS or ABS+PC combinations; therefore, their manufacturing processes need to avoid high temperatures to prevent softening of the plastic material. For clear polishing paint, which is typically an industrial complete bright clear polishing paint (with a glossness over 70 degree), a lower cost PU resin is used as the main solvent, and performed in a baking temperature between 40° C.˜60° C. The typical clear polishing paint requires only low temperature bakes, which will not affect the appearance of the plastic material, and therefore is very popular with plastic materials. Mostly, the products coated with the typical clear polishing paint described above is packaged with packing materials such as pearl bags (multi-film bags). However, the deforming temperature of the packing materials is around 40° C. In other words, the packing material releases acids when the temperature is over 40° C., and the acids released from the packing materials begin to stick onto the clear polishing paint layer of the product, where an adhesion mark is formed, and thus damages the product appearance.

Therefore, it is desirable to provide a coating method of a clear polishing paint with low manufacturing cost and high temperature resistance to mitigate and/or obviate the aforementioned problems.

### SUMMARY OF THE INVENTION

The present invention provides a coating method for a clear polishing paint, which can tightly combine with the base of the electronic product being coated. The coating method for a clear polishing paint of the present invention can be applied to any acrylic PU clear polishing paint. As shown by the results in the following experimental tests, the clear polishing paint layer can maintain the original coated surface under repeated temperature fluctuations between −20° C. and 60° C., with no clear polishing paint softening and no impression marking problems.

The coating method for a clear polishing paint of present invention comprises the steps of:

a) providing a substrate coated with a base coat, and a clear polishing paint mixture solution, the clear polishing paint mixture solution contains a hardener part and a PU clear paint;

b) coating the clear polishing paint mixture solution on a surface of the substrate, and heating the substrate coated with the clear polishing paint mixture solution at 60° C.˜75° C. for 0.5˜2 hours; and c) keeping the substrate coated with the clear polishing paint mixture solution stationary.

In the present invention, the PU clear paint comprises acrylic polyol, and the PU clear paint can be added thereto a flow agent, a defoaming agent or an adhesion agent. Typical PU clear paint can be directly applied onto a substrate, or added thereto a hardener part and then be applied. The hardener is used for delaying the solidification of the clear coat. In the method of the present invention, the type of the hardener is not specific, but preferably a hardener containing isocyanate. The PU clear paint and the hardener individually is selected from the group consisting of xylene, ethyl acetate, butyl acetate, an aromatic solvent and the combination thereof.

Before the coating process of the clear polishing paint, a clear polishing paint mixture solution is prepared by mixing the PU clear paint and the hardener part. The viscosity of the clear polishing paint mixture solution is not limited, but preferably is a viscosity with a flow speed of 10-15 seconds. The PU clear paint and the hardener is mixed in a specific ratio to form the clear polishing paint mixture solution, the mixing ratio is not limited, preferably the PU clear paint and hardener has a mixing ratio between 2:1˜6:1.

The viscosity of the clear polishing paint mixture solution can be adjusted by adding a thinner. The thinner is preferably xylene, ethyl acetate, butyl acetate, aromatic solvent or the combination thereof.

Other objects, advantages, and novel features of the invention will become more apparent from the following detailed description when taken in conjunction with the accompanying drawings.

### BRIEF DESCRIPTION OF THE DRAWINGS

FIG. 1 is a picture showing a surface of the product in embodiment 2 having no adhesion mark after the varied-temperature test.

FIG. 2 is a picture showing a surface of the product in comparative example 1 having adhesion marks after the varied-temperature test.

FIG. 3 is a picture showing a surface of the product in comparative example 2 having adhesion marks after the varied-temperature test.

### DETAILED DESCRIPTION OF THE PREFERRED EMBODIMENT

In this embodiment, a clear acrylic polishing paint and conventional substrate materials (e.g. ABS, or ABS+PC blends) used widely in vehicle industries are utilized. Typical substrates having base coats may still require tests to ensure that the base coat on the typical substrates is compatible to the clear polishing paint layer that subsequently applied. In this embodiment, the coating procedures for the base coat on the surface of the substrate has been selected for suitability with the clear polishing paint layer.

First, a substrate is provided, which is an LCD shell with a particular shape; a basic cleaning process is performed upon the substrate to remove dust or substrate particles; when finished, a first base coat is sprayed onto the substrate, and the substrate is heated at a temperature of about 55° C. for 30 minutes. The substrate with the base coat is then permitted to dry. However, it may be desirable that the drying time does not exceed 24 hours to avoid the situation of the clear polishing paint not compatible to the base coat later. After applying the first base coat, when the temperature of the substrate has cooled to room temperature, the coating process for the clear polishing paint can be performed, and typically the process takes 30 minutes.

A primary solvent and a hardener part in a two-part epoxy PU clear polishing paint (#0225 PU clear paint, Guan-Far company) are mixed prior to the coating process for the clear coat, forming a clear polishing paint mixture. It may be desirable that the mixing time of the two part epoxy is less than 6 hours, as the viscosity of the mixture will continuously increase, which affects subsequent processes. A mixing ratio of the primary solvent to hardener may be between 2:1˜6:1, and the viscosity of the mixture may be thinned by adding standard thinner (PU3T thinner, Guan-Far company). For liquid flow speeds, the viscosity of this clear polishing paint mixture solution may have a flow speed between 10˜15 seconds. If the mixing ratio of the primary solvent to the hardener part is about 6:1, the viscosity should preferably have a flow speed between 11˜13 seconds. Further, if the mixing ratio of the primary solvent to the hardener part is 2:1, the viscosity should preferably have a flow speed between 12˜14 seconds.

The substrate coated with the base coat is then fully covered with the clear polishing paint mixture, and is baked at variant temperatures for different periods of time. After baking, the substrate should remain stationary for several days to permit observation of viscous adhesion between the clear polishing paint and an HDPE plastic film.

To better understand the stability of the above-mentioned substrate under variant temperature cycles, viscous adhesion tests under storage conditions were performed.

A double-faced, multi-film bag was used for packaging of the stationary substrates. The test conditions are: 60° C., 39% humidity; 40° C., 90% humidity; and −20° C. The testing period was for 168 hours, and a Hitachi Walk-in Chamber ER-35 MHP was used as the test apparatus.

The testing steps included: prior to performing the test, carefully observe the appearance of each sample object; taking pictures and record condition of the sample objects; placing the sample objects into different testing apparatus to undergo different testing conditions; after the testing,—the appearance of the sample is checked, photos are taken, compared and results are recorded.

Standards for sample object evaluation included: verifying that the front top cover, the front lower cover and the main cover exhibit no cracking, discoloration, chipping or adhesive problems. A 1000 Lux illumination device was used, with an illuminating direction 30° off of the vertical on the object being examined, and at a distance of 30 cm. The observation angle between the eye of the examiner and the object was 60° horizontally and 45° vertically.

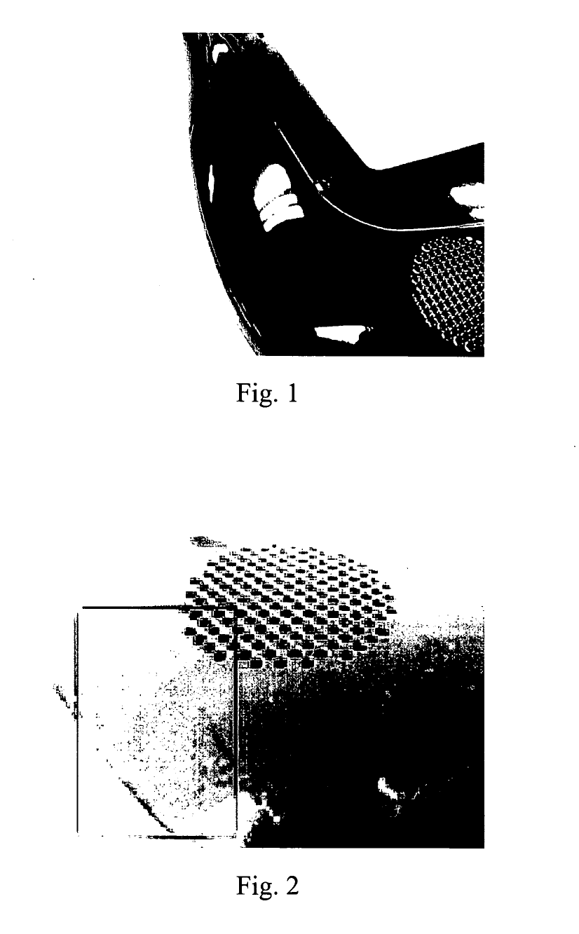

Test results are shown in Table 1. The materials of the base coats on the examined sample object, the coating conditions, and the packaging materials were all identical, the differences being in the baking time of the coating process for the clear polishing paint, and in the stationary times, that is, in the amount of time the object was held stationary. As shown in Table 1, the baking temperatures in embodiments 1-3 were between 55° C.˜70° C., and the baking times were between 30 minutes and 2 hours, which all showed adhesion problems prevented. Please refer to the test results shown in FIG. 1 of the embodiment 2. The stationary times are not constrained; after the baking process, the object can be kept stationary for 3 to 7 days to avoid adhesion problems.

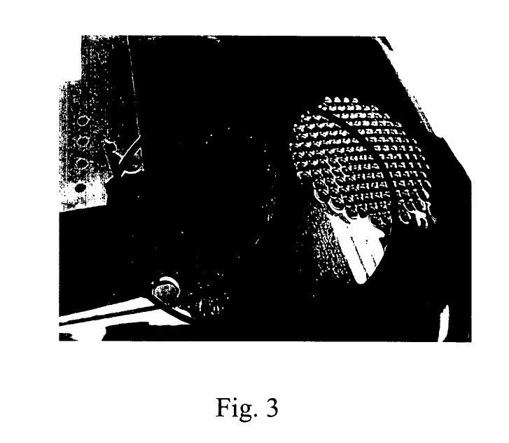

As shown in the results for comparative examples 1 to 3, for baking temperatures lower than 55° C. or higher than 70° C., and regardless of the baking time, the products exhibit adhesion problems. Additionally, if the temperature is too high, the outer shell may also exhibit deformation problems, which increases the number of variables during test. Please refer to FIGS. 2 and 3 of the comparative examples 1 and 2 for adhesion problems.

TABLE 1

| | Baking | | | |
|---|---|---|---|---|
| | temperature | Baking time | Stationary time | Adhesion |
| Embodiment | (□) | (minutes) | (days) | status |
| 1 | 55 | 30 | 3 | No |
| 2 | 55 | 30 | 6 | No |
| 3 | 70 | 40 | 7 | No |
| Comparative | 75 | 30 | 1 | Yes |
| example 1 | | | | |
| Comparative | 45 | 40 | 2 | Yes |
| example 2 | | | | |
| Comparative | 80 | 360 | 4 | Yes |
| example 3 | | | | |

With different baking times and stationary times, it is clear that for the solvent in the paint to evaporate completely, the stationary time needs to be longer if the baking time is short. Alternatively, if the baking time is longer, the stationary time can be shorter.

Although the present invention has been explained in relation to its preferred embodiment, it is to be understood that many other possible modifications and variations can be made without departing from the spirit and scope of the invention as hereinafter claimed.

1. A coating method for a clear polishing paint to prevent adhesion marks, comprising the steps of:
providing a plastic substrate coated with a base coat, and a clear polishing paint mixture solution, the clear polishing paint mixture solution containing a hardener part and a PU clear paint;
coating the clear polishing paint mixture solution on a surface of the substrate, and heating the substrate coated with the clear polishing paint mixture solution at 60° C.˜75° C. for 0.5˜2 hours; and
keeping the substrate coated with the clear polishing paint mixture solution stationary.

2. The method as claimed in claim 1, wherein the PU clear paint comprises acrylic polyol.

3. The method as claimed in claim 1, wherein the PU clear paint further comprises a flow agent, a defoaming agent or an adhesion agent.

4. The method as claimed in claim 1, wherein the PU clear paint and the hardener further comprise a solvent individually.

5. The method as claimed in claim 4, wherein the solvent is selected from the group, consisting of xylene, ethyl acetate, butyl acetate, an aromatic solvent and the combination thereof.

6. The method as claimed in claim 1, wherein the hardener comprises isocyanate.

7. The method as claimed in claim 1, wherein the clear polishing paint mixture solution has a viscosity with a flow speed of 10˜15 seconds.

8. The method as claimed in claim 1, wherein the PU clear paint and the hardener are mixed in a ratio between 2:1˜6:1.

9. The method as claimed in claim 1, wherein a viscosity of the clear polishing paint mixture solution is adjusted by adding a thinner.

10. The method as claimed in claim 9, wherein the thinner is selected from the group consisting of xylene, ethyl acetate, butyl acetate, aromatic solvent and the combination thereof.
